(19) United States
(12) Patent Application Publication
(10) Pub. No.: US 2023/0391393 A1
(43) Pub. Date: Dec. 7, 2023

(54) BALL SCREW DEVICE, ELECTRIC POWER STEERING DEVICE, AND LUBRICANT FOR BALL SCREW DEVICE

(71) Applicant: Hitachi Astemo, Ltd., Hitachinaka-shi (JP)

(72) Inventor: Masato IKEDA, Hitachinaka-shi (JP)

(73) Assignee: Hitachi Astemo, Ltd., Hitachinaka-shi (JP)

(21) Appl. No.: 18/451,568

(22) Filed: Aug. 17, 2023

Related U.S. Application Data
(63) Continuation of application No. PCT/JP2021/013827, filed on Mar. 31, 2021.

(51) Int. Cl. B62D 5/04; F16H 25/22; F16H 57/04

(52) U.S. Cl. CPC B62D 5/0448; F16H 57/0497; F16H 25/2233

(57) ABSTRACT

A ball screw device includes: a screw shaft that has a first screw groove on an outer circumferential surface thereof; a cylindrical nut member that has a second screw groove on an inner circumferential surface thereof; plural rolling elements that can roll in a rolling path formed between the first screw groove and the second screw groove; and a lubricant applied to the rolling path, wherein the lubricant has a loss tangent tanδ larger than 0.11, which is measured by dynamic viscoelasticity measurement performed at a temperature of 25° C., an angular frequency of 10 rad/s, and an amount of strain of 0.01%.

### CROSS REFERENCE TO RELATED APPLICATIONS

This application is a Continuation of International Patent Application No. PCT/JP2021/013827 filed on Mar. 31, 2021, the content of which is incorporated herein by reference in its entirety.

### FIELD OF THE INVENTION

The present invention relates to a ball screw device, an electric power steering device, and a lubricant for the ball screw device.

### BACKGROUND OF THE INVENTION

In the past, there has been a technology that suppresses the generation of noise in ball screw devices by using lubricants with specific compositions and physical properties.

For example, in Japanese Patent Application Laid-Open Publication No. 2003-287038, in a ball screw device including: a screw shaft extended in the axial direction and having a screw groove extending in the axial direction; a ball nut having a screw groove facing the screw groove of the screw shaft and supported on the screw shaft so as to be relatively movable along the axial direction through rolling of a large number of balls inserted between these screw grooves; and a holding piece arranged between each of the balls to hold the balls, a lubricant combined with a lubricant, base oil kinematic viscosity of which is more than 150 mm²/s (40° C.), is used as the lubricant. The lubricant used in the ball screw device described in Japanese Patent Application Laid-Open Publication No. 2003-287038 increases the oil film strength by increasing the base oil kinetic viscosity; accordingly, as a result, the running noise generated when the ball is rolling is reduced, and the noise of the ball screw device can be reduced.

### CITATION LIST

### Patent Literature

Patent Document 1: Japanese Patent Application Laid-Open Publication No. 2003-287038

### Technical Problem

Ball screw devices are sometimes used in high load environments, such as electric power steering devices in automobiles. If the ball screw device is operated under high loads, there is a risk that the noise generated by the rolling elements and the rolling path is increased.

An object of the present invention is to provide a ball screw device, etc. that can suppress noise generated from rolling elements and a rolling path in operating.

### SUMMARY OF THE INVENTION

### Solution to Problem

The present invention is a ball screw device including: a screw shaft having a first screw groove on an outer circumferential surface thereof; a cylindrical nut member having a second screw groove on an inner circumferential surface thereof; plural rolling elements that can roll in a rolling path formed between the first screw groove and the second screw groove; and a lubricant applied to the rolling path, wherein the lubricant has a loss tangent tanδ larger than 0.11, which is measured by dynamic viscoelasticity measurement performed at a temperature of 25° C., an angular frequency of 10 rad/s, and an amount of strain of 0.01%.

Moreover, the present invention is an electric power steering device including: an electric motor; and the above-described ball screw device that converts a driving force of rotational motion of the electric motor into a driving force of linear motion.

Furthermore, the present invention is a lubricant for a ball screw device to be applied to a rolling path for rolling elements in the ball screw device, wherein the lubricant has a loss tangent tanδ larger than 0.11, which is measured by dynamic viscoelasticity measurement performed at a temperature of 25° C., an angular frequency of 10 rad/s, and an amount of strain of 0.01%.

### Advantageous Effects of Invention

It is possible for the present invention to provide a ball screw device, etc. that can suppress noise generated from rolling elements and a rolling path in operating.

### BRIEF DESCRIPTION OF THE DRAWINGS

FIG. 1 is a schematic configuration diagram of an electric power steering device related to an exemplary embodiment of the present invention;

FIG. 2 is a cross-sectional view of the II-II portion in FIG. 1, which is also a cross-sectional view of a transmission mechanism part;

FIG. 3 is a cross-sectional view of the III-III portion in FIG. 1, which is also a cross-sectional view of an assist part;

FIG. 4 is a cross-sectional view of the IV-IV portion in FIG. 3, which views the assist part in the axial direction;

FIG. 5 is a perspective view showing a state before assembling a first housing, an intermediate housing, and a second housing;

FIG. 6 is a table showing the composition, a loss tangent tanδ, and operating noise effects of grease in examples and comparative examples;

FIG. 7 is a schematic view of an operating noise evaluation device; and

FIG. 8 is a graph showing the relationship between the loss tangent tanδ and the operating noise effects.

### DETAILED DESCRIPTION OF THE INVENTION

Hereinafter, exemplary embodiments according to the present invention will be described in detail with reference to attached drawings.

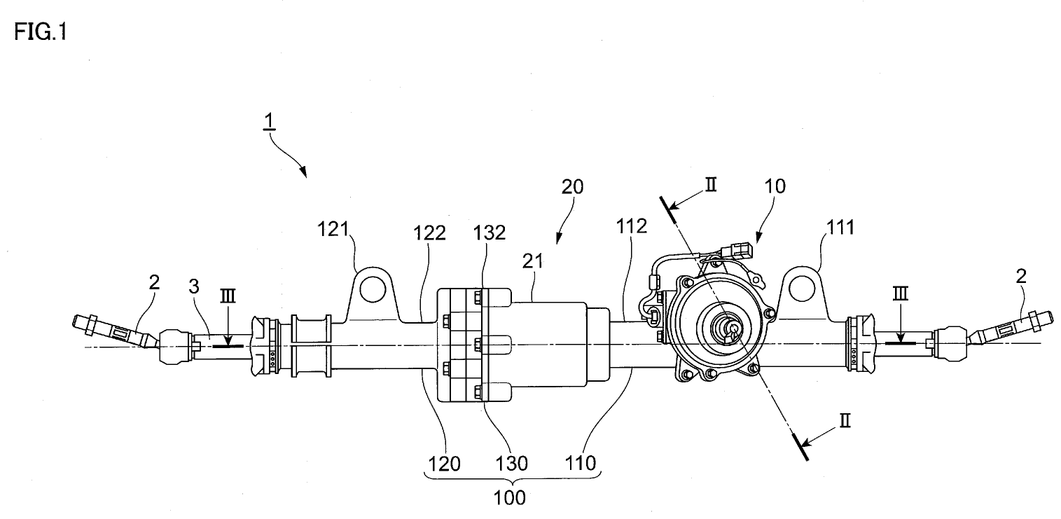

FIG. 1 is a schematic configuration diagram of an electric power steering device 1 related to a first exemplary embodiment.

As shown in FIG. 1, the electric power steering device (hereinafter, sometimes referred to as the “steering device”) 1 related to the first exemplary embodiment is a steering system for arbitrarily changing the traveling direction of a vehicle. The steering device 1 related to the first exemplary embodiment is a rack-assisted power steering device.

The steering device 1 includes: tie rods 2 coupled to respective right and left wheels (not shown) as rolling wheels via steering knuckle arms (not shown); and a rack shaft 3 coupled to the tie rods 2. In addition, the steering device 1 also includes a transmission mechanism part 10 transmitting the steering force from a steering wheel (not shown) provided in the vehicle to the rack shaft 3. In addition, the steering device 1 includes an electric motor 21 and has an assist part 20 that transmits the driving force of the electric motor 21 to the rack shaft 3 as steering assistance force, to thereby assist the movement of the rack shaft 3.

Note that, in the following description, the longitudinal direction of the rack shaft 3 is referred to as the “axial direction”, and the circumferential direction with respect to the central axis of the rack shaft 3 is referred to as “circumferential direction” in some cases.

The steering device 1 also includes a housing 100 that covers the perimeter of part of an outer circumferential surface of the rack shaft 3 and supports the rack shaft 3 to be movable in the axial direction. The housing 100 includes: a first housing 110 with a first leg part 111 to be fastened to the body of the vehicle (not shown); a second housing 120 with a second leg part 121; and an intermediate housing 130 arranged between the first housing 110 and the second housing 120.

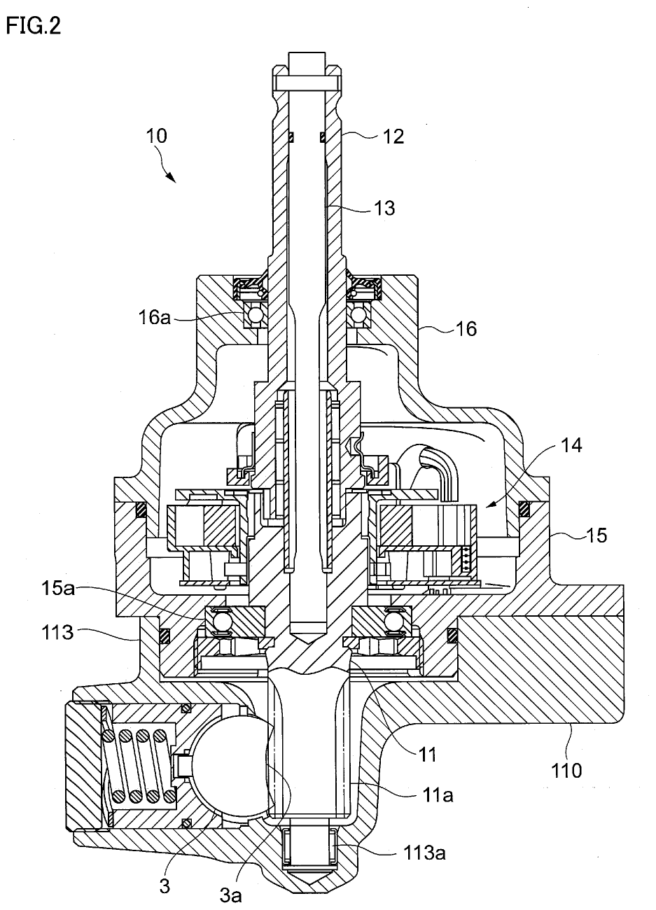

The first housing 110 has a cylinder-shaped first cylindrical part 112 that passes the rack shaft 3 inside thereof. The first housing 110 also has a transmission mechanism support part 113 (refer to FIG. 2) that supports the transmission mechanism part 10.

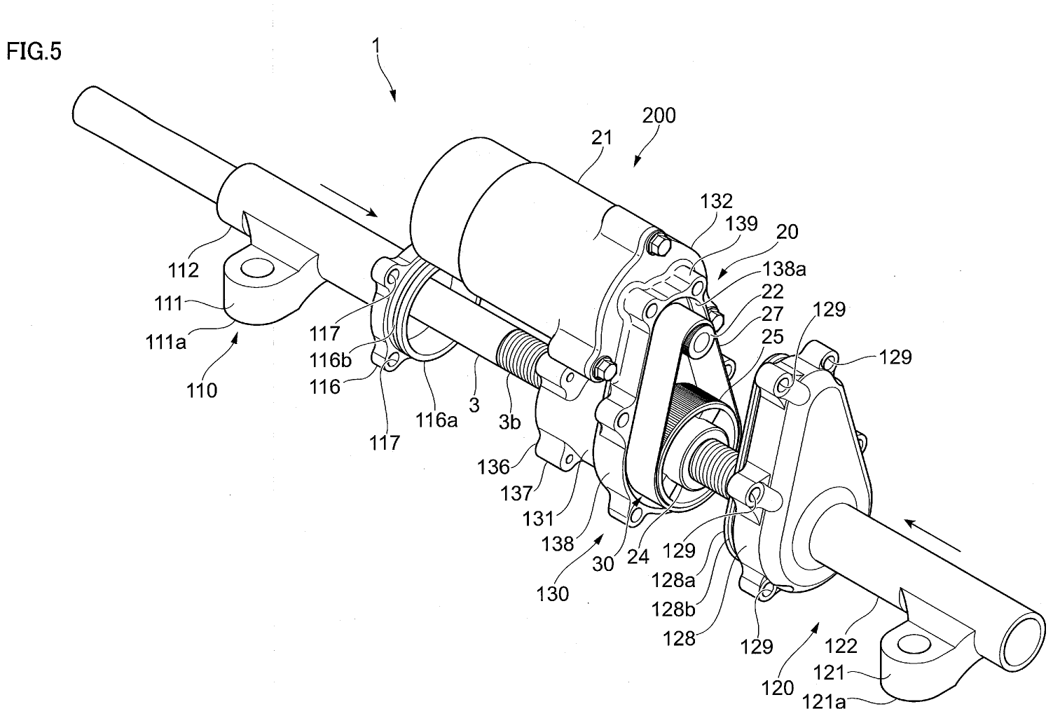

The first leg part 111 is provided to protrude from the first cylindrical part 112, and includes a cylindrical portion on which a through hole is formed to pass a bolt to be used for fastening to the body of the vehicle (not shown), and a portion connecting the cylindrical portion and the first cylindrical part 112. The lower end surface of the first leg part 111 (the surface opposite to the direction in which the input shaft 12 protrudes, which will be described later) serves as a mounting seat surface 111a (refer to FIG. 5) that is placed on the vehicle body when the steering device 1 is fastened to the vehicle body.

The transmission mechanism support part 113 will be described in detail later.

The second housing 120 has a cylinder-shaped second cylindrical part 122 that passes the rack shaft 3 inside thereof.

The second leg part 121 is provided to protrude from the second cylindrical part 122, and includes a cylindrical portion on which a through hole is formed to pass a bolt to be used for fastening to the body of the vehicle (not shown), and a portion connecting the cylindrical portion and the second cylindrical part 122. The lower end surface of the second leg part 121 (the surface opposite to the direction in which the input shaft 12 protrudes) serves as a mounting seat surface 121a (refer to FIG. 5) that is placed on the vehicle body when the steering device 1 is fastened to the vehicle body.

The intermediate housing 130 includes a cylinder-shaped intermediate cylindrical part 131 that passes the rack shaft 3 inside thereof, and a motor support part 132 that supports the electric motor 21.

The motor support part 132 will be described in detail later.

### (Transmission Mechanism Part 10)

FIG. 2 is a cross-sectional view of the II-II portion in FIG. 1, which is also a cross-sectional view of the transmission mechanism part 10.

The transmission mechanism part 10 includes: a pinion shaft 11 on which pinion 11a constituting a rack and pinion mechanism together with a rack 3a formed on the rack shaft 3; and an input shaft 12 on which the steering force from the steering wheel (not shown) is inputted. The transmission mechanism part 10 also has a torsion bar 13 coupled to the pinion shaft 11 and the input shaft 12.

In addition, the transmission mechanism part 10 includes a torque sensor 14 that detects the steering torque of the steering wheel based on the amount of torsion of the torsion bar 13. The torque sensor 14 outputs the detection result of the steering torque to an ECU (Electronic Control Unit) (not shown). The ECU controls the electric motor 21 based on the steering torque detected by torque sensor 14.

The transmission mechanism part 10 also has a sensor housing 15 that covers the perimeter of the torque sensor 14 and a cover 16 that covers an opening part of the sensor housing 15.

The sensor housing 15 is fastened to the transmission mechanism support part 113 of the first housing 110 with a bolt (not shown) and the cover 16 is fastened to the sensor housing 15 with a bolt (not shown).

The transmission mechanism support part 113 and the sensor housing 15 include a bearing 113a and a bearing 15a, respectively, that support the pinion shaft 11 to be rotatable. The cover 16 includes a bearing 16a that supports the input shaft 12 to be rotatable. The sensor housing 15 and the cover 16 are fastened to the transmission mechanism support part 113; accordingly, the pinion shaft 11 and the torque sensor 14 are housed inside and one end portion of each of the input shaft 12 and the torsion bar 13 is protruded to the outside.

### (Assist Part 20 Including Ball Screw Device 4)

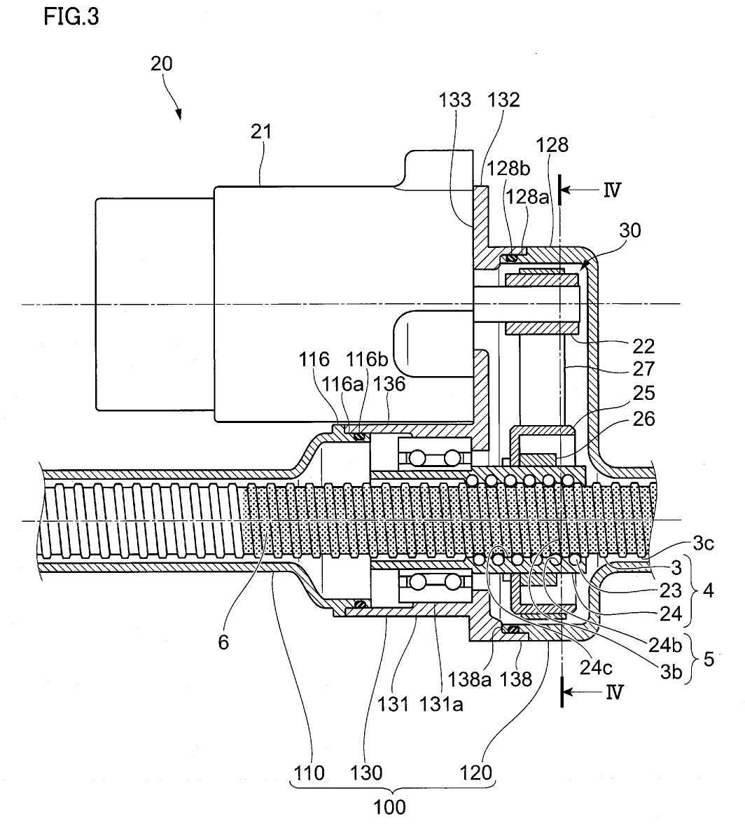

FIG. 3 is a cross-sectional view of the III-III portion in FIG. 1, which is also a cross-sectional view of the assist part 20.

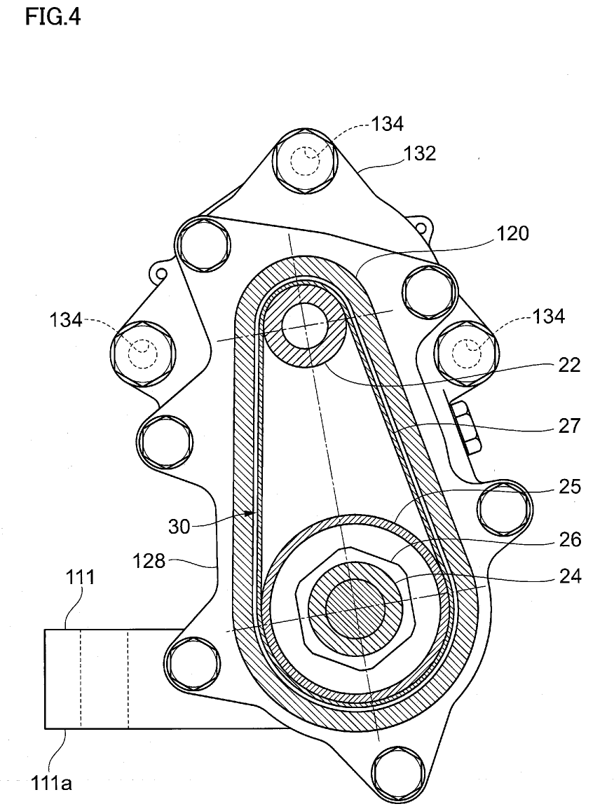

FIG. 4 is a cross-sectional view of the IV-IV portion in FIG. 3, which views the assist part 20 in the axial direction.

FIG. 5 is a perspective view showing a state before assembling the first housing 110, the intermediate housing 130, and the second housing 120.

The assist part 20 includes the electric motor 21 and a drive pulley 22 mounted on an output shaft of the electric motor 21. In addition, the assist part 20 includes: many balls 23 (a specific example of rolling elements); and a ball nut 24 (a specific example of a nut member) attached to a first screw groove 3b formed on an outer circumferential surface 3c of the rack shaft 3 (a specific example of a screw shaft) via the balls 23. Here, the ball nut 24 has a second screw groove 24b on an inner circumferential surface 24c, and the balls 23 are provided to be capable of rolling in a rolling path 5 formed by the first screw groove 3b and the second screw groove 24b. In addition, as shown by shading in FIG. 3, the rolling path 5 formed by the first screw groove 3b and the second screw groove 24b and the balls 23 are coated with a grease 6, which is a specific example of a lubricant. Note that the grease 6 will be described in detail later.

The ball screw device 4 in in the exemplary embodiment is configured with the rack shaft 3, the balls 23, the ball nut 24 and the applied grease 6.

In addition, the assist part 20 includes a driven pulley 25 that rotates with the ball nut 24, and a locknut 26 that fastens the driven pulley 25 to the outer circumference of the ball nut 24. The assist part 20 also includes a single endless belt 27 running between the drive pulley 22 and the driven pulley 25.

The drive pulley 22, the balls 23, the ball nut 24, the driven pulley 25, the belt 27, etc. constitute a conversion unit 30 that converts the rotational driving force of the electric motor 21 into the movement of the rack shaft 3 in the axial direction.

The intermediate cylindrical part 131 of the intermediate housing 130 includes a bearing 131a that supports the ball nut 24 of the assist part 20 to be rotatable.

The motor support part 132 of the intermediate housing 130 has a motor mounting surface 133 for mounting the electric motor 21. The motor mounting surface 133 is processed to reduce the surface roughness to ensure sealing properties between the electric motor 21 and the intermediate housing 130. In addition, the motor support part 132 is provided with plural (in the exemplary embodiment, three) through holes 134 formed to pass the bolts for fastening the electric motor 21.

### (Coupling Part Between First Housing 110 and Intermediate Housing 130 and Coupling Part Between Intermediate Housing 130 and Second Housing 120)

At the end portion of the first cylindrical part 112 in the first housing 110, which is closer to the intermediate housing 130, there is a first coupling part 116 to be coupled to the end portion of the intermediate cylindrical part 131 in the intermediate housing 130, which is closer to the first housing 110. In the first coupling part 116, plural (in the exemplary embodiment, four) through holes 117 for passing bolts.

At the end portion of the intermediate cylindrical part 131 in the intermediate housing 130, which is closer to the first housing 110, there is a second coupling part 136 to be coupled to the first coupling part 116 of the first cylindrical part 112 in the first housing 110. The second coupling part 136 includes plural (in the exemplary embodiment, four) bosses 137 in each of which a female screw is formed to tighten the bolt used for fastening the first coupling part 116 of the first housing 110.

Then, the first coupling part 116 of the first housing 110 is provided with a first convex part 116a protruding from a mating surface with the second coupling part 136 of the intermediate housing 130. The end portion of the first convex part 116a of the first coupling part 116 and the end portion of the second coupling part 136 (the end portion of the intermediate cylindrical part 131 closer to the first coupling part 116) are circular when viewed in the axial direction. An O-ring 116b is attached on the outer circumferential portion of the first convex part 116a of the first coupling part 116. The first coupling part 116 and the second coupling part 136 are coupled to each other in the state in which the first convex part 116a of the first coupling part 116 is fitted into the inner circumferential surface of the intermediate cylindrical part 131 of the intermediate housing 130. The gap between the first convex part 116a of the first coupling part 116 and the intermediate cylindrical part 131 of the intermediate housing 130 is sealed with the O-ring 116b.

Moreover, at the end portion of the intermediate housing 130 closer to the second housing 120, a third coupling part 138, which is coupled to the end portion of the second housing 120 closer to the intermediate housing 130, is provided.

At the end portion of the second housing 120 closer to the intermediate housing 130, a fourth coupling part 128, which is coupled to the third coupling part 138 of the intermediate housing 130, is provided. The second cylindrical part 122 of the second housing 120 is provided on the opposite side of the intermediate housing 130 with respect to the fourth coupling part 128.

The coupling of the third coupling part 138 of the intermediate housing 130 and the fourth coupling part 128 of the second housing 120 forms a containing part that contains the conversion unit 30 of the assist part 20. The shape of the third coupling part 138 of the intermediate housing 130 and the fourth coupling part 128 of the second housing 120, in other words, the containing part, as viewed in the axial direction follows the shape of the outer circumferential surface of the endless belt 27 running between the drive pulley 22 and the driven pulley 25 of the assist part 20, as shown in FIG. 4. The drive pulley 22, the driven pulley 25, and the belt 27 of the assist part 20 protrude to the outside from the third coupling part 138, and the outer circumference of the belt 27 is covered with the fourth coupling part 128 of the second housing 120.

The third coupling part 138 of the intermediate housing 130 includes plural (in the exemplary embodiment, six) bosses 139 in each of which a female screw is formed to tighten the bolt used for fastening the fourth coupling part 128 of the second housing 120. On the other hand, in the fourth coupling part 128 of the second housing 120, the same number (in the exemplary embodiment, six) of through holes 129, as the bosses 139, for passing bolts are formed.

The fourth coupling part 128 of the second housing 120 is provided with a fourth convex part 128a protruding from a mating surface with the third coupling part 138 of the intermediate housing 130. On the other hand, in the third coupling part 138 of the intermediate housing 130, a third concave part 138a concaved from a mating surface with the fourth coupling part 128 of the second housing 120 is formed. When viewed in the axial direction, the fourth convex part 128a of the fourth coupling part 128 and the third concave part 138a of the third coupling part 138 have a shape that follows the shape of the outer circumferential surface of the belt 27, as shown in FIG. 4. An O-ring 128b is attached on the outer circumferential portion of the fourth convex part 128a of the fourth coupling part 128. The third coupling part 138 and the fourth coupling part 128 are coupled to each other in the state in which the fourth convex part 128a of the fourth coupling part 128 is fitted into the third concave part 138a of the third coupling part 138. The gap between the fourth convex part 128a of the fourth coupling part 128 and the third concave part 138a of the third coupling part 138 is sealed with O-ring 128b.

As described above, the electric power steering device 1 includes the electric motor 21 that provides the driving force for turning the wheels (not shown) in response to the operation of the steering wheel (not shown), and the ball screw device 4 that transmits the driving force of the electric motor 21 to the wheels.

The electric power steering device 1 detects the steering torque T applied to the steering wheel at the torque sensor 14, drives the electric motor 21 in accordance with the detected torque, and transmits the driving force to the ball screw device 4 via the belt 27. Furthermore, the ball screw device 4 converts the driving force, which is rotational motion, to the driving force of linear motion of the rack shaft 3 in the axial direction, and applies the force to the wheels via the tie rods 2.

When the ball screw device 4 is operated, the plural balls 23 rotate on the rolling path 5 between the first screw groove 3b of rack shaft 3 and the second screw groove 24b of ball nut 24 while being pressurized. At this time, the balls 23 come into contact with the rolling path 5, to thereby generate vibration energy. In addition, two different balls 23 come into contact with each other to generate the vibration energy. Part of these vibration energy is absorbed by the grease 6, and then released as heat. In addition, the remaining vibration energy that was not released as heat is released to the outside as it is. The vibration energy released to the outside is the noise generated from the balls 23 and rolling path 5.

Therefore, to suppress the noise generated from the balls 23 and the rolling path 5, the ratio of energy released as heat after being absorbed by the grease 6 should be increased.

### (Loss Tangent Tanδ)

Here, the loss tangent tanδ will be described.

The loss tangent tanδ is the ratio between the loss shear modulus G″ and the storage shear modulus G′ when external force is applied to a viscoelastic material such as grease (refer to Equation (1)).

The loss shear modulus G″ is a parameter corresponding to a viscous component of dynamic viscoelasticity, and corresponds to the energy released to the outside as heat out of the energy absorbed by the viscoelastic material upon receiving the external force. In addition, the storage shear modulus G′ is a parameter corresponding to an elastic component of the dynamic viscoelasticity, and corresponds to the energy stored in the viscoelastic material out of the energy absorbed by the viscoelastic material upon receiving the external force.

[Math. 1]

tanδ=G″/G′ (1)

Consequently, use of the grease with a large loss tangent tanδ increases the ratio of the energy released to the outside as heat and suppresses the noise from the balls 23 and the rolling path 5. In contrast thereto, use of the grease with a small loss tangent tanδ increases the ratio of the energy released to the outside as the vibration energy and increases the noise from the balls 23 and the rolling path 5.

As a result of diligent research, the inventors of the present invention found that use of the grease 6 with a loss tangent tanδ larger than 0.11 in the dynamic viscoelasticity measurements at a temperature of 25° C., an angular frequency of 10 rad/s, and an amount of strain of 0.01% suppressed the noise generated by the balls 23 and the rolling path 5 even in the ball screw device 4 used under a high load environment. Note that, in the following description, the “loss tangent tanδ” is a value obtained in the dynamic viscoelasticity measurements at the temperature of 25° C., the angular frequency of 10 rad/s, and the amount of strain of 0.01%, unless otherwise described.

The grease 6 like this will be described in detail below.

### (Grease)

The composition of the grease 6 in the exemplary embodiment, that is, the types of the base oil, the thickener, and the additive, are not particularly limited as long as the loss tangent tanδ is larger than 0.11.

Hereinafter, each of the base oil, the thickener, and the additive used for the grease 6 in the exemplary embodiment will be described, and specific examples will be shown.

### [Base Oil]

Specific examples of the base oil that can be used include: various types of synthetic oils such as synthetic hydrocarbon oils containing PAO (polyalphaolefin), ether oils such as alkyl ether and alkyl diphenyl ether, ester oils such as diester and polyol esters, silicone oils, and fluorine oils. In addition to the synthetic oils, mineral oils such as paraffin-based mineral oils and naphthene-based mineral oils can be used. In addition, these oils can be used not only by themselves, but also by mixing two or more types.

Moreover, the content (blending amount) of the base oil in the grease 6 is not particularly limited if the loss tangent tanδ is larger than 0.11, but, for example, the content is set within the range of 50 mass % to 95 mass %.

Furthermore, the base oil kinematic viscosity is not particularly limited. However, if the base oil kinetic viscosity becomes too high, the resistance of the grease 6 during the operation of the ball screw device 4 increases, and there is a risk of increasing the torque loss of the ball screw device 4. Consequently, it is preferable to set the base oil kinetic viscosity at 40° C. not more than 100 mm²/s, and it is more preferable to set thereof not more than 80 mm²/s.

Note that the “base oil kinetic viscosity” in this specification refers to the kinetic viscosity of the base oil of the grease measured in accordance with JIS K2220 23.

### [Thickener]

As the thickener, metal soap such as lithium soap or sodium soap can be used. In more detail, lithium stearate, lithium 12-hydroxystearate, etc. can be used. In addition, composite metal soap such as lithium complex soap and calcium complex soap can be used.

In addition, for example, an urea compound such as a diurea compound, a triurea compound, and a polyurea compound can be used as the thickener. In general, the urea compound can be obtained by synthesizing polyisocyanate and amine in the base oil. As the amine raw material used at that time, for example, aliphatic amine such as hexylamine, octylamine, dodecylamine, and stearylamine, alicyclic amine such as cyclohexylamine, and aromatic amine such as p-toluidine and aniline are used. These amine raw materials may be used alone or in combination to synthesize the urea compound. In addition, as the polyisocyanate raw material, phenylenediisocyanate, tolylenediisocyanate, diphenylmethane diisocyanate, etc. are used.

Note that the content (blending amount) of the thickener in the grease 6 is not particularly limited if the loss tangent tanδ is larger than 0.11, but, for example, the content is set within the range of 1 mass % to 30 mass %.

### [Additive]

Furthermore, various types of additives such as an antioxidant, a corrosion inhibitor, a dispersant, an oily agent, a solid lubricant, a viscous agent, and an extreme pressure agent may be added to the grease 6 as needed. In addition, plural different types of additives may be used.

Here, the solid lubricants are solid additives added to improve the lubricity of the grease, which include MoS₂ (molybdenum disulfide), PTFE (polytetrafluoroethylene), MCA (melamine cyanurate), etc. In addition, the viscous agents are additives added to increase the viscosity of a liquid in the grease, which include, for example, viscous agents of polybutene base, polyisobutylene base, polymethacrylate base and olefin copolymer base. Furthermore, the extreme pressure agents are additives added to improve the lubricity of the grease in extreme pressure environments, which include a phosphate compound such as phosphate ester and phosphite ester, a sulfur compound such as sulfurized fat, and an organometallic compound such as ZnDTP (zinc dialkyldithiophosphate) and MoDTC (molybdenum dialkyldithiocarbamate).

Note that the content (blending amount) of the additive in the grease 6 is not particularly limited if the loss tangent tanδ is larger than 0.11. Preferably, the total content of various types of additives is set to the range of not more than 10 mass parts against the total amount of base oil and thickener of 100 mass parts.

The grease 6, which is a specific example of a lubricant in the present invention, can be obtained at the desired consistency by using suitable types and blending amount of the above-described base oil, thickener, and additive, and applying appropriate preparation method of the grease 6.

The consistency is not particularly limited if the loss tangent tanδ is larger than 0.11, but is preferably set within the range from 250 to 360.

Note that the “consistency” in this specification is the worked penetration of the grease measured in accordance with JIS K2220 7.

### Examples and Comparative Example of Grease

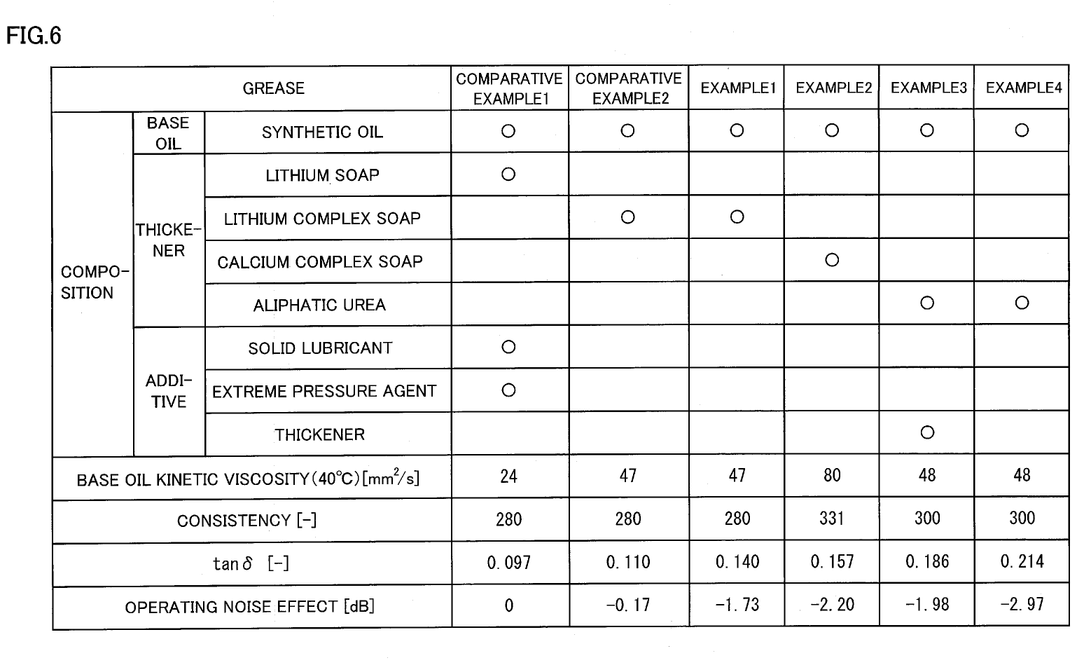

Next, examples and comparative examples of the grease 6 in the present invention will be described using FIGS. 6 to 8.

FIG. 6 is a table showing the composition, a loss tangent tanδ, and operating noise effects (to be described later) of the grease in each of the examples and the comparative examples.

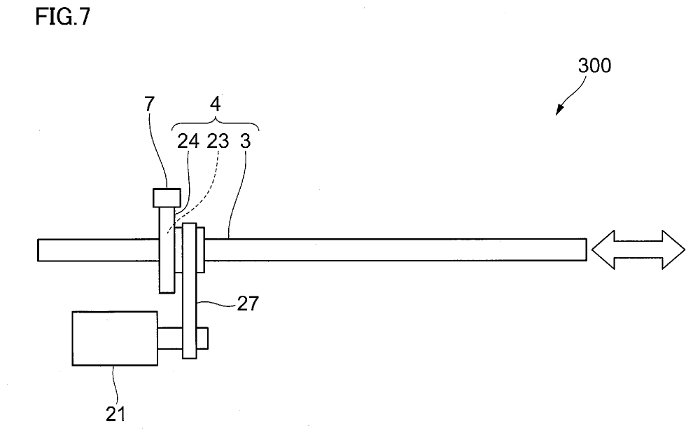

FIG. 7 is a schematic view of an operating noise evaluation device.

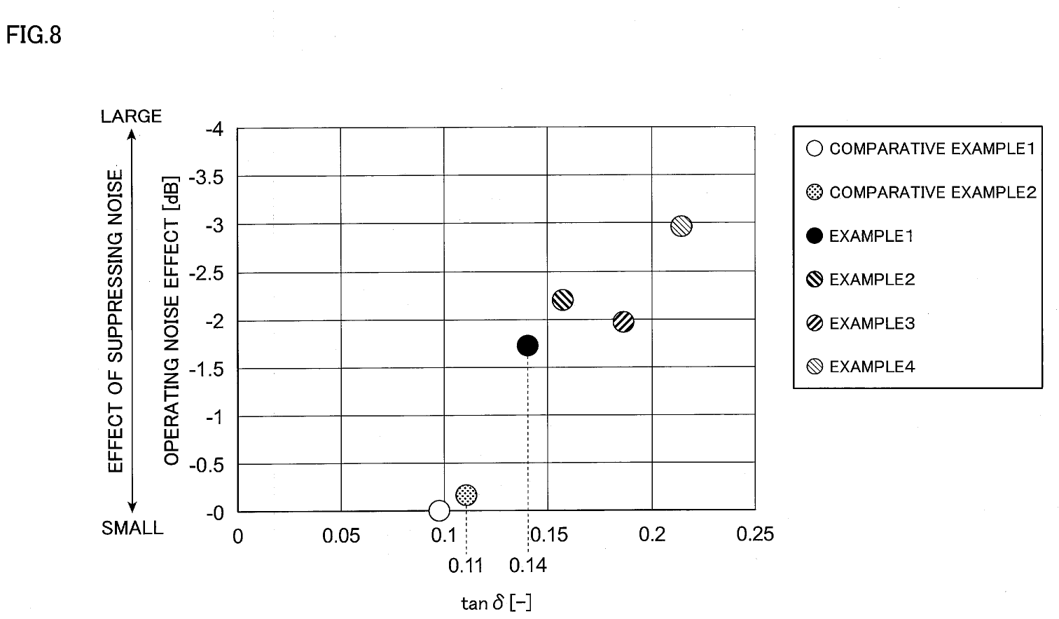

FIG. 8 is a graph showing the relationship between the loss tangent tanδ and the operating noise effects in the grease in each of the examples and the comparative examples.

### [Details of Grease in Examples and Comparative Examples]

In the examples and the comparative examples in FIG. 6, the synthetic oil was used as the base oil. Note that the detailed composition of the synthetic oil is appropriately set so that the physical properties such as base oil kinetic viscosity and loss tangent tanδ become the target values. Therefore, the composition of the synthetic oil is sometimes different in the grease in each of the examples and the comparative examples.

For the thickener, the lithium soap, the lithium complex soap, the calcium complex soap, and the aliphatic urea were used.

As the additive, the solid lubricant and the extreme pressure agent were added to the Comparative example 1. In addition, in Example 3, a thickener was added.

In addition, in the grease of the examples and the comparative examples, the base oil kinematic viscosity at 40° C. was set within the range of 24 mm²/s to 80 mm²/s. Furthermore, the consistency was set within the range of 280 to 331.

### [Details of Dynamic Viscoelasticity Measurement]

The loss tangent tanδ shown in FIG. 6 was obtained by the dynamic viscoelasticity measurement performed under the following conditions. In more detail, the storage shear modulus G′ and the loss shear modulus G″ were measured in the state where the grease to be evaluated was placed between an upper plate and a lower plate of a dynamic viscoelasticity measurement device and the upper plate was moved under the following conditions, to thereby calculate the loss tangent tanδ by Equation (1).

Dynamic viscoelasticity measurement device: Rheometer (MCR302 manufactured by Anton Paar GmbH)

Plate: φ 25 mm parallel plate

Gap between plates: 1 mm

Temperature: 25° C.

Angular frequency: 10 rad/s (constant)

Amount of strain: 0.01% (constant)

### [Operating Noise Effects]

The operating noise effects shown in FIG. 6 is a value showing the effects of suppressing the noise (vibration [dB]) of each grease, which is compared to Comparative example 1. Specifically, the value, which is determined by Equation (2), corresponds to the difference between the operating noise in the grease to be evaluated and the operating noise in Comparative example 1.

Note that the operating noise effects have a negative value when the operating noise in the target grease is reduced (the noise is suppressed) as compared to the operating noise in Comparative example 1. In addition, the greater the effect of suppressing the noise of the target grease, the smaller the value of the operating noise effects.

[Math. 2]

Operating noise effects=operating noise in target grease−operating noise in Comparative example 1 (2)

Here, the measuring method of operating noise in each grease will be described.

As shown in FIG. 7, the operating noise evaluation device 300 is configured with the ball screw device 4, the electric motor 21, the belt 27 that transmits the driving force from the electric motor 21 to the ball screw device 4, and an acceleration sensor 7 attached to the ball nut 24 of the ball screw device 4. Note that the ball screw device 4 in the operating noise evaluation device 300 has the rack shaft 3 of φ 28.75 mm, the ball diameter of 5/32 inches (q) 3.97 mm), and a lead width of 7 mm/rev.

In addition, the rolling path 5 (the first screw groove 3b and the second screw groove 24b) and the rolling elements (the balls 23) of the ball screw device 4 are coated with the grease to be evaluated.

Then, the operating noise is the value of the vibration [dB] detected by the acceleration sensor 7 when the operating noise evaluation device 300 is operated under the following conditions. Note that, in operation, the rack shaft 3 reciprocates in the axial direction as indicated by the arrow in the figure.

Temperature: 25° C.

Moving speed of rack shaft 3: 90 mm/s

Moving distance of rack shaft 3: ±50 mm

As shown in FIG. 6, the loss tangent tanδ in Comparative examples 1 and 2 is not more than 0.11, and the loss tangent tanδ in Examples 1 to 4 is larger than 0.11. In more detail, the loss tangent tanδ in Examples 1 to 4 was 0.140 to 0.214.

The operating noise effects were −1.73 to −2.97 in Examples 1 to 4, but remained at −0.17 in Comparative example 2. In this way, in the examples in which the loss tangent tanδ was larger than 0.11, the effect of suppressing noise became greater.

To additionally describe, even in the case where the composition, the base oil kinematic viscosity, consistency, etc. of the grease 6 were changed as in Examples 1 to 4, if the loss tangent tanδ was the value larger than 0.11, the effect of suppressing noise increased.

FIG. 8 is a graph showing the relationship between the loss tangent tanδ and the operating noise effects in the examples and the comparative examples shown in FIG. 6, where the horizontal axis indicates the loss tangent tanδ, and the vertical axis indicates the value of the operating noise effects. Note that, in the vertical axis, the value of the operating noise effects decreases from the bottom to the top, which indicates that the effect of suppressing noise increases.

As shown in FIG. 8, except for Example 3, in Examples 1, 2, and 4 and in Comparative examples 1 and 2, the value of the operating noise effects decreases as the loss tangent tanδ increases, and the effect of suppressing noise becomes higher.

In addition, in Examples 1 to 4, in which the loss tangent tanδ is not less than 0.14, the effect of suppressing noise is significantly greater as compared to Comparative examples 1 and 2, in which the loss tangent tanδ is not more than 0.11.

Here, as compared to Example 4, Example 3 has small value of the loss tangent tanδ, and thereby the effect of suppressing noise is small. Example 3 is different from Example 4 only in the point that the viscous agent was added.

From the result, to increase the effect of suppressing noise, in addition to increasing the loss tangent tanδ larger than 0.11, it is preferable not to add the viscous agent as the additive.

As a result of the above, in the ball screw device 4, which is used in a high load environment and the noise is louder when the grease in Comparative example 1 is used, the noise can be reduced by using the grease 6 having the loss tangent tanδ larger than 0.11 as in Examples 1 to 4, instead of the grease in Comparative example 1.

In addition, application of the ball screw device 4 using the grease 6 with the loss tangent tanδ larger than 0.11 to the electric power steering device of an automobile makes it possible to reduce noise generated from the automobile.

So far the exemplary embodiment has been described; however, various modifications may be available without deviating from the gist of the present invention.

For example, the above-described configuration of ball screw device 4 is merely a specific example; any ball screw devices are acceptable if the loss tangent tanδ of the lubricant applied in the rolling path 5 is larger than 0.11. In addition, the above-described configuration of the electric power steering device 1 is merely a specific example, and it is sufficient to have an electric motor that provides the driving force and the ball screw device 4 of the present invention.

Moreover, lubricants with different composition, base oil kinematic viscosity and consistency from the above-described Examples 1 to 4 of the grease 6 may be used, and any lubricants for ball screw device are acceptable if the loss tangent tanδ is larger than 0.11.

Furthermore, in the exemplary embodiment, the description was given of the specific example in which the ball screw device 4 is used for the electric power steering device 1; however, the ball screw device 4 is not limited to the use. For example, the ball screw device 4 may be used in other devices that can use the mechanism of the ball screw device, such as machine tools or injection molding machines.

### REFERENCE SIGNS LIST

1 Electric power steering device
3 Rack shaft
3b First screw groove
3c Outer circumferential surface
4 Ball screw device
5 Rolling path
6 Grease
21 Electric motor
23 Ball
24 Ball nut
24b Second screw groove
24c Inner circumferential surface

1. A ball screw device comprising:
a screw shaft having a first screw groove on an outer circumferential surface thereof;
a cylindrical nut member having a second screw groove on an inner circumferential surface thereof;
a plurality of rolling elements that can roll in a rolling path formed between the first screw groove and the second screw groove; and
a lubricant applied to the rolling path, wherein
the lubricant has a loss tangent tanδ of not less than 0.14, which is measured by dynamic viscoelasticity measurement performed at a temperature of 25° C., an angular frequency of 10 rad/s, and an amount of strain of 0.01%.

2. The ball screw device according to claim 1, wherein the lubricant contains no viscous agent.

3. An electric power steering device comprising:
an electric motor; and
the ball screw device according to claim 1 that converts a driving force of rotational motion of the electric motor into a driving force of linear motion.

4. A lubricant for a ball screw device to be applied to a rolling path for rolling elements in the ball screw device, wherein the lubricant has a loss tangent tanδ of not less than 0.14, which is measured by dynamic viscoelasticity measurement performed at a temperature of 25° C., an angular frequency of 10 rad/s, and an amount of strain of 0.01%.

5. The lubricant for a ball screw device according to claim 4, wherein the lubricant contains no viscous agent.

6. An electric power steering device comprising:
an electric motor; and
the ball screw device according to claim 2 that converts a driving force of rotational motion of the electric motor into a driving force of linear motion.
